(19) United States
(12) Patent Application Publication
(10) Pub. No.: US 2024/0365192 A1
(43) Pub. Date: Oct. 31, 2024

(54) CELL SWITCH HANDOVER

(71) Applicant: Nokia Technologies Oy, Espoo (FI)

(72) Inventors: Sandra HOPPE, Munich (DE); Hans Thomas HÖHNE, Espoo (FI)

(21) Appl. No.: 18/687,551

(22) PCT Filed: Sep. 1, 2021
(86) PCT No.: PCT/EP2021/074143

§ 371 Date: Feb. 28, 2024

(51) Int. Cl. H04W 36/08; H04W 36/00

(52) U.S. Cl. CPC H04W 36/083; H04W 36/0061

(57) ABSTRACT

According to an example embodiment, a network node device is configured to when the network node device is connected to a first satellite of a non-terrestrial network, identify at least one client device needing to be served by the network node device, wherein the at least one client device is currently served by a second network node device via a first cell provided by a second satellite of the non-terrestrial network; in response to identifying that the at least one client device needs to be served by the network node device, provide a second cell to at least one the client device via the second satellite; and after the at least one client device has performed a handover from the first cell to the second cell, switch the second cell to be provided by the first satellite.

### TECHNICAL FIELD

The present application generally relates to the field of wireless communications. In particular, the present application relates to a network node device, a satellite, and related methods and computer programs.

### BACKGROUND

Non-terrestrial networks (NTN) include all networks that use an airborne or spaceborne platform, such as satellites, high-altitude platforms, and/or drones, as a part of the network. Satellites can be classified in terms of their altitude, from low-Earth orbit (LEO) to geostationary Earth orbit (GEO) satellites. LEO satellites are deployed in large constellations and move with respect to the surface of the Earth with a speed of approximately 7.5 km/s to maintain their orbit. Their advantage is global and high-speed communication with a low delay in comparison to traditional Geostationary Earth orbit (GEO) satellites due to the lower round-trip time (RTT). The movement of the LEO satellite with respect to the Earth is one of the main challenges for LEO communications and will lead to very frequent handovers, even if the is not moving.

### SUMMARY

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

An example embodiment of a network node device comprises at least one processor and at least one memory comprising computer program code. The at least one memory and the computer program code are configured to, with the at least one processor, cause the network node device to: when the network node device is connected to a first satellite of a non-terrestrial network, identify at least one client device needing to be served by the network node device, wherein the at least one client device is currently served by a second network node device via a first cell provided by a second satellite of the non-terrestrial network; in response to identifying that the at least one client device needs to be served by the network node device, provide a second cell to at least one the client device via the second satellite; and after the at least one client device has performed a handover from the first cell to the second cell, switch the second cell to be provided by the first satellite. The network node device can, for example, enable the client device to handover from the second network node device to the network node device without the need for additional antenna beams.

An example embodiment of a network node device comprises means for performing: when the network node device is connected to a first satellite of a non-terrestrial network, identify at least one client device needing to be served by the network node device, wherein the at least one client device is currently served by a second network node device via a first cell provided by a second satellite of the non-terrestrial network; in response to identifying that the at least one client device needs to be served by the network node device, provide a second cell to at least one the client device via the second satellite; and after the at least one client device has performed a handover from the first cell to the second cell, switch the second cell to be provided by the first satellite.

In an example embodiment, alternatively or in addition to the above-described example embodiments, the first cell and/or the second cell are Earth-fixed cells and the at least one client device needs to be served by the network node device due to the second satellite moving out-of-range for serving the at least one client device. The network node device can, for example, enable the client device to handover from the second network node device to the network node device when the second network node device can no longer server the client device via the second satellite.

In another example embodiment, alternatively or in addition to the above-described example embodiments, the at least one memory and the computer program code are further configured to, with the at least one processor, cause the network node device to, after providing the second cell to the at least one client device via the second satellite, instruct the at least one client device to perform a handover from the first cell to the second cell. The network node device can, for example, explicitly signal to the client device when to perform the handover.

In another example embodiment, alternatively or in addition to the above-described example embodiments, the at least one memory and the computer program code are further configured to, with the at least one processor, cause the network node device to, before switching the second cell to be provided by the first satellite, inform a timing of the switch to the at least one client device and/or instruct the at least one client device not to perform scheduling and/or measurements during the switch. The network node device can, for example, make sure that the client device does not perform unnecessary scheduling and/or measurements during the switch.

In another example embodiment, alternatively or in addition to the above-described example embodiments, the first satellite and the second satellite are connected via an inter-satellite link and/or the network node device and the second network node device are connected via an inter-gNB link and wherein the second cell is routed to the second satellite via the inter-satellite link and/or the inter-gNB link. The network node device can, for example, efficiently provide the second cell via the inter-satellite link and/or inter-gNB link. In another example embodiment, alternatively or in addition to the above-described example embodiments, the at least one memory and the computer program code are further configured to, with the at least one processor, cause the network node device to: collect new satellite parameter settings for the at least one client device; and inform the new satellite parameter settings to the at least one client device before switching the second cell to be provided by the first satellite. The network node device can, for example, enable the client device to use the new satellite parameter settings after the switch.

In another example embodiment, alternatively or in addition to the above-described example embodiments, the new satellite parameter settings comprise at least one of: Doppler shift, pathloss, transmit power, satellite ephemeris, and/or timing advance. The network node device can, for example, enable the client device to obtain necessary satellite parameter settings.

In another example embodiment, alternatively or in addition to the above-described example embodiments, the at least one memory and the computer program code are further configured to, with the at least one processor, cause the network node device to: implement a switch gap during which the network node device switches the second cell to be provided by the first satellite; and instruct the at least one client device not to perform scheduling and/or measurements during the switch gap and/or instructs the at least one client device to take the new satellite parameter settings into use after the switch gap. The network node device can, for example, make sure that the client device does not perform unnecessary scheduling and/or measurements during the switch gap.

An example embodiment of a satellite comprises at least one processor and at least one memory comprising computer program code. The at least one memory and the computer program code are configured to, with the at least one processor, cause the satellite to: provide a first cell to at least one client device, wherein the at least one client device is served by a second network node device via the first cell; in response to the at least one client device needing to be served by a first network node device, provide a second cell to the at least one client device, wherein the at least one client device is served by the first network node device via the second cell; and after the at least one client device has performed a handover from the first cell to the second cell, switch off the second cell, allowing the second cell to be provided by a first satellite. The satellite can, for example, enable the client device to handover from the second network node device to the first network node device without the need for additional antenna beams.

An example embodiment of a satellite comprises means for performing: provide a first cell to at least one client device, wherein the at least one client device is served by a second network node device via the first cell; in response to the at least one client device needing to be served by a first network node device, provide a second cell to the at least one client device, wherein the at least one client device is served by the first network node device via the second cell; and after the at least one client device has performed a handover from the first cell to the second cell, switch off the second cell, allowing the second cell to be provided by a first satellite.

In an example embodiment, alternatively or in addition to the above-described example embodiments, the at least one memory and the computer program code are further configured to, with the at least one processor, cause the satellite to provide the first cell and the second cell using a single antenna beam. The satellite can, for example, enable the client device to handover from the second network node device to the first network node device without the need for additional antenna beams by providing the first cell and the second cell in parallel using a single antenna beam.

In another example embodiment, alternatively or in addition to the above-described example embodiments, the first cell and/or the second cell are Earth-fixed cells and the at least one client device needs to be served by the first network node device due to the satellite moving out-of-range for serving the at least one client device. The satellite can, for example, enable the client device to handover from the second network node device to the first network node device when the satellite is no longer able to serve the client device.

An example embodiment of a client device comprises at least one processor and at least one memory comprising computer program code. The at least one memory and the computer program code are configured to, with the at least one processor, cause the client device to: identify that the client device needs to be served by a first network node device, wherein the first network node device is connected to a first satellite of a non-terrestrial network, wherein the client device is currently served by a second network node device via a first cell provided by a second satellite of the non-terrestrial network; in response to identifying that the client device needs to be served by the first network node device, identify a second cell served by the first network node device and provided by the second satellite; and perform a handover from the first cell to the second cell, wherein the second cell is switched to being provided by the first satellite after the handover. The client device can, for example, perform a handover from the second network node device to the first network node device without the need for additional antenna beams from the satellites.

An example embodiment of a client device comprises means for performing: identify that the client device needs to be served by a first network node device, wherein the first network node device is connected to a first satellite of a non-terrestrial network, wherein the client device is currently served by a second network node device via a first cell provided by a second satellite of the non-terrestrial network; in response to identifying that the client device needs to be served by the first network node device, identify a second cell served by the first network node device and provided by the second satellite; and perform a handover from the first cell to the second cell, wherein the second cell is switched to being provided by the first satellite after the handover.

In an example embodiment, alternatively or in addition to the above-described example embodiments, the at least one memory and the computer program code are further configured to, with the at least one processor, cause the client device to: obtain new satellite parameter settings for the first satellite from the first network node device; and use the new satellite parameter settings after the second cell has been switched to being provided by the first satellite. The client device can, for example, obtain new satellite parameters settings to be used for the first satellite.

An example embodiment of a method comprises: when a network node device is connected to a first satellite of a non-terrestrial network, identifying at least one client device needing to be served by the network node device, wherein the at least one client device is currently served by a second network node device via a first cell provided by a second satellite of the non-terrestrial network; in response to identifying that the at least one client device needs to be served by the network node device, providing a second cell to at least one the client device via the second satellite; and after the at least one client device has performed a handover from the first cell to the second cell, switching the second cell to be provided by the first satellite.

An example embodiment of a method comprises: providing a first cell to at least one client device, wherein the at least one client device is served by a second network node device via the first cell; in response to the at least one client device needing to be served by a first network node device, providing a second cell to the at least one client device, wherein the at least one client device is served by the first network node device via the second cell; and after the at least one client device has performed a handover from the first cell to the second cell, switching off the second cell, allowing the second cell to be provided by a first satellite.

An example embodiment of a method comprises: identifying that a client device needs to be served by a first network node device, wherein the first network node device is connected to a first satellite of a non-terrestrial network, wherein the client device is currently served by a second network node device via a first cell provided by a second satellite of the non-terrestrial network; in response to identifying that the client device needs to be served by the first network node device, identifying a second cell served by the first network node device and provided by the second satellite; and performing a handover of the client device from the first cell to the second cell, wherein the second cell is switched to being provided by the first satellite after the handover.

An example embodiment of a computer program product comprises program code configured to perform the method according to any of the above example embodiments, when the computer program product is executed on a computer.

### DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 illustrates an example embodiment of the subject matter described herein illustrating a client device;

FIG. 2 illustrates an example embodiment of the subject matter described herein illustrating a satellite;

FIG. 3 illustrates an example embodiment of the subject matter described herein illustrating a client device;

FIG. 4 illustrates an example embodiment of the subject matter described herein illustrating cell switching via an inter-gNB link in a system with transparent satellites;

FIG. 5 illustrates an example embodiment of the subject matter described herein illustrating cell switching via an inter-satellite link in a system with transparent satellites;

FIG. 6 illustrates an example embodiment of the subject matter described herein illustrating cell switching via an inter-satellite link in a system with regenerative satellites;

FIG. 7 illustrates an example embodiment of the subject matter described herein illustrating a flow chart representation of cell switching;

FIG. 8 illustrates an example embodiment of the subject matter described herein illustrating a signalling diagram representation of cell switching;

FIG. 9 illustrates an example embodiment of the subject matter described herein illustrating a flow chart representation of client device cell switching;

FIG. 10 illustrates an example embodiment of the subject matter described herein illustrating a switch gap;

FIG. 11 illustrates an example embodiment of the subject matter described herein illustrating a signalling diagram for switch gap signalling;

FIG. 12 illustrates an example embodiment of the subject matter described herein illustrating a flow chart representation of a method;

FIG. 13 illustrates an example embodiment of the subject matter described herein illustrating a flow chart representation of another method; and

FIG. 14 illustrates an example embodiment of the subject matter described herein illustrating a flow chart representation of another method.

Like reference numerals are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present disclosure may be constructed or utilized. The description sets forth the functions of the example and the sequence of steps for constructing and operating the example. However, the same or equivalent functions and sequences may be accomplished by different example embodiments.

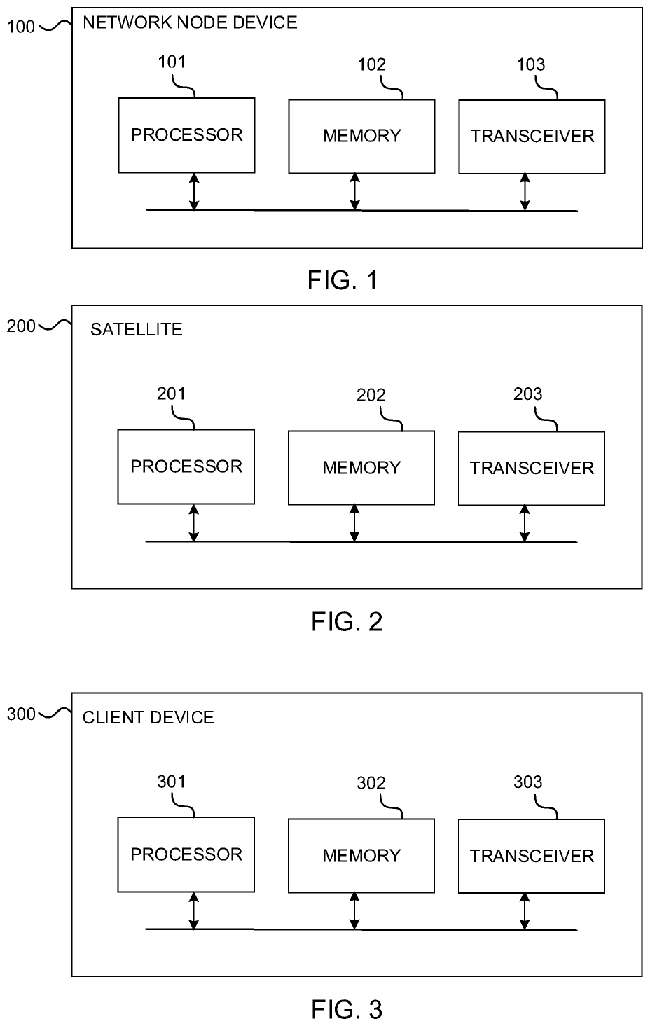

FIG. 1 is a block diagram of a network node device 100 configured in accordance with an example embodiment.

The network node device 100 may comprises one or more processors 101 and one or more memories 102 that comprise computer program code. The network node device 100 may also comprise at least one transceiver 103, as well as other elements, such as an input/output module (not shown in FIG. 1), and/or a communication interface (not shown in FIG. 1).

According to an example embodiment, the at least one memory 102 and the computer program code are configured to, with the at least one processor 101, cause the network node device 100 to when the network node device is connected to a first satellite of a non-terrestrial network, identify at least one client device needing to be served by the network node device, wherein the at least one client device is currently served by a second network node device via a first cell provided by a second satellite of the non-terrestrial network.

For example, the second satellite may not soon be able to provide the first cell to the at least one client device due to, for example, movement of the second satellite. Thus, the network node device 100 may soon need to serve the at least client device. The network node device 100 may identify the at least one client device needing to be served by the network node device 100 via, for example, dedicated signalling or via some other mechanism.

The network node device 100 may be further configured to, in response to identifying that the at least one client device needs to be served by the network node device 100, provide a second cell to at least one the client device via the second satellite.

The network node device 100 may serve the at least one client device using the second cell via the second satellite while the second satellite is still capable of providing the second cell. For example, the second satellite has not yet moved out of range. The first cell and the second cell may have a substantially similar footprint. For example, the second satellite may provide the first cell and the second cell using a single antenna beam.

The network node device may be further configured to, after the at least one client device has performed a handover (HO) from the first cell to the second cell, switch the second cell to be provided by the first satellite.

The network node device 100 may, for example, instruct the second satellite to switch off the second cell and instruct the first satellite to switch on the second cell. Thus, the second cell is switched from being provided by the second satellite to being provided by the first satellite.

After the at least one client device has performed the handover and the second cell has been switched to the first satellite, the at least one client device can be served by the network node device 100 via the first cell provided by the first satellite even after the second satellite has moved and is out of range. Thus, serving of the at least one client device has been switched to the network node device 100 and the first satellite.

Herein, the network node device 100 may also be referred to as a first network node device for clarity.

Although the network node device 100 may be depicted to comprise only one processor 101, the network node device 100 may comprise more processors. In an example embodiment, the memory 102 is capable of storing instructions, such as an operating system and/or various applications.

Furthermore, the processor 101 may be capable of executing the stored instructions. In an example embodiment, the processor 101 may be embodied as a multi-core processor, a single core processor, or a combination of one or more multi-core processors and one or more single core processors. For example, the processor 101 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 101 may be configured to execute hard-coded functionality. In an example embodiment, the processor 101 is embodied as an executor of software instructions, wherein the instructions may specifically configure the processor 101 to perform the algorithms and/or operations described herein when the instructions are executed.

The memory 102 may be embodied as one or more volatile memory devices, one or more non-volatile memory devices, and/or a combination of one or more volatile memory devices and non-volatile memory devices. For example, the memory 102 may be embodied as semiconductor memories (such as mask ROM, PROM (programmable ROM), EPROM (erasable PROM), flash ROM, RAM (random access memory), etc.).

The network node device 100 may be embodied in, for example, a base station (BS). The base station may comprise, for example, a gNodeB (gNB) or any such device providing an air interface for client devices to connect to the wireless network via wireless transmissions. When the network node device 100 is configured to implement some functionality, some component and/or components of the network node device 100, such as the at least one processor 101 and/or the memory 102, may be configured to implement this functionality. Furthermore, when the at least one processor 101 is configured to implement some functionality, this functionality may be implemented using program code comprised, for example, in the memory 102. For example, if the network node device 100 is configured to perform an operation, the at least one memory 102 and the computer program code can be configured to, with the at least one processor 101, cause the network node device 100 to perform that operation.

Some terminology used herein may follow the naming scheme of 4G or 5G technology in its current form. However, this terminology should not be considered limiting, and the terminology may change over time. Thus, the following discussion regarding any example embodiment may also apply to other technologies.

FIG. 2 illustrates an example embodiment of the subject matter described herein illustrating a satellite.

The satellite 200 may comprises one or more processors 201 and one or more memories 202 that comprise computer program code. The satellite 200 may also comprise at least one transceiver 203, as well as other elements, such as an input/output module (not shown in FIG. 2), and/or a communication interface (not shown in FIG. 2).

According to an example embodiment, the at least one memory 202 and the computer program code are configured to, with the at least one processor 201, cause the satellite 200 to provide a first cell to at least one client device, wherein the at least one client device is served by a second network node device via the first cell.

The satellite 200 may be further configured to, in response to the at least one client device needing to be served by a first network node device, provide a second cell to the at least one client device, wherein the at least one client device is served by the first network node device via the second cell.

The satellite 200 may be further configured to, after the at least one client device has performed a handover from the first cell to the second cell, switch off the second cell, allowing the second cell to be provided by a first satellite.

The satellite 200 may, for example, receive an instruction from the first network node device 100 to switch off the second cell.

Herein, the satellite 200 may also be referred to as a second satellite for clarity.

Furthermore, the processor 201 may be capable of executing the stored instructions. In an example embodiment, the processor 201 may be embodied as a multi-core processor, a single core processor, or a combination of one or more multi-core processors and one or more single core processors. For example, the processor 201 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

In an example embodiment, the processor 201 may be configured to execute hard-coded functionality. In an example embodiment, the processor 201 is embodied as an executor of software instructions, wherein the instructions may specifically configure the processor 201 to perform the algorithms and/or operations described herein when the instructions are executed.

The memory 202 may be embodied as one or more volatile memory devices, one or more non-volatile memory devices, and/or a combination of one or more volatile memory devices and non-volatile memory devices. For example, the memory 202 may be embodied as semiconductor memories (such as mask ROM, PROM (programmable ROM), EPROM (erasable PROM), flash ROM, RAM (random access memory), etc.).

When the satellite 200 is configured to implement some functionality, some component and/or components of the satellite 200, such as the at least one processor 201 and/or the memory 202, may be configured to implement this functionality. Furthermore, when the at least one processor 201 is configured to implement some functionality, this functionality may be implemented using program code comprised, for example, in the memory 202. For example, if the satellite 200 is configured to perform an operation, the at least one memory 202 and the computer program code can be configured to, with the at least one processor 201, cause the satellite 200 to perform that operation.

FIG. 3 is a block diagram of a client device 300 configured in accordance with an example embodiment. The client device 300 may comprises one or more processors 301 and one or more memories 302 that comprise computer program code. The client device 300 may also comprise at least one transceiver 303, as well as other elements, such as an input/output module (not shown in FIG. 3), and/or a communication interface (not shown in FIG. 3).

According to an example embodiment, the at least one memory 302 and the computer program code are configured to, with the at least one processor 301, cause the client device 300 to identify that the client device 300 needs to be served by a first network node device, wherein the first network node device is connected to a first satellite of a non-terrestrial network, wherein the client device is currently served by a second network node device via a first cell provided by a second satellite of the non-terrestrial network.

The client device 300 may be further configured to, in response to identifying that the client device 300 needs to be served by the first network node device, identify a second cell served by the first network node device and provided by the second satellite.

The client device 300 may be further configured to perform a handover from the first cell to the second cell, wherein the second cell is switched to being provided by the first satellite after the handover.

Furthermore, the processor 301 may be capable of executing the stored instructions. In an example embodiment, the processor 301 may be embodied as a multi-core processor, a single core processor, or a combination of one or more multi-core processors and one or more single core processors. For example, the processor 301 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 301 may be configured to execute hard-coded functionality. In an example embodiment, the processor 301 is embodied as an executor of software instructions, wherein the instructions may specifically configure the processor 301 to perform the algorithms and/or operations described herein when the instructions are executed.

The memory 302 may be embodied as one or more volatile memory devices, one or more non-volatile memory devices, and/or a combination of one or more volatile memory devices and non-volatile memory devices. For example, the memory 302 may be embodied as semiconductor memories (such as mask ROM, PROM (programmable ROM), EPROM (erasable PROM), flash ROM, RAM (random access memory), etc.).

When the client device 300 is configured to implement some functionality, some component and/or components of the client device 300, such as the at least one processor 301 and/or the memory 302, may be configured to implement this functionality. Furthermore, when the at least one processor 301 is configured to implement some functionality, this functionality may be implemented using program code comprised, for example, in the memory 302. For example, if the client device 300 is configured to perform an operation, the at least one memory 302 and the computer program code can be configured to, with the at least one processor 301, cause the client device 300 to perform that operation.

The client device 300 may comprise, for example, a mobile phone, a smartphone, a tablet computer, a smart watch, or any hand-held or portable device or any other apparatus, such as a vehicle, a robot, or a repeater. The client device may also be referred to as a user equipment (UE) or similar.

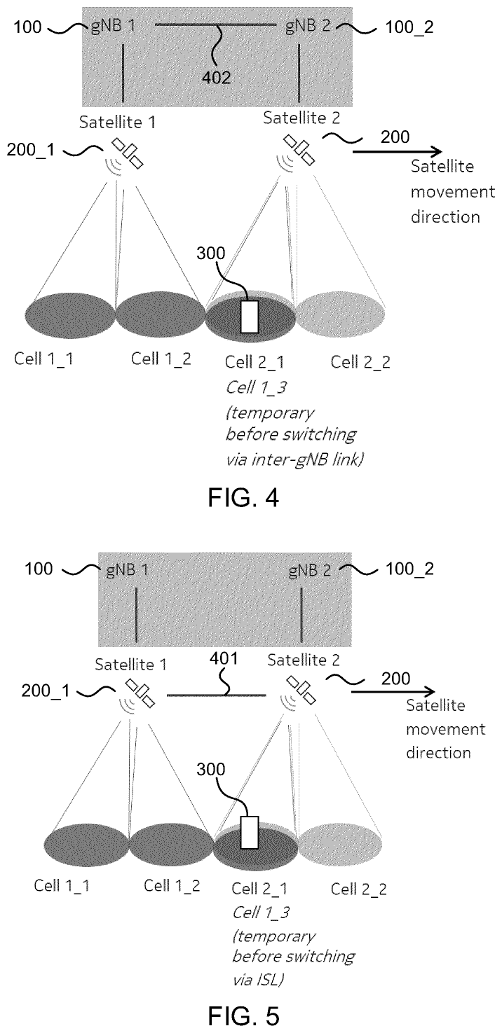

FIG. 4 illustrates an example embodiment of the subject matter described herein illustrating cell switching via an inter-gNB link in a system with transparent satellites.

There are two basic deployment options for the cells broadcasted by non-geostationary satellites, such as LEO satellites. The first option is placing the cells below the satellite. This means that the cells move with respect to the surface of the Earth according to the orbital trajectory of the satellite. This may be referred to as Earth-moving cells. The second option is fixing the cells on the surface of the Earth. This is achieved by continuously steering the beams on the satellite to maintain a fixed cell position on Earth. This may be referred to Earth-fixed cells.

In the example embodiment of FIG. 4, Earth-fixed cells are illustrated. A first satellite provides cells 1_1 and 1_2 while the second satellite provides cells 2_1 and 2_2.

In the example embodiment of FIG. 4, the first network node device 100 and a second network node device 100_2 are placed on the ground. In such a configuration, the first satellite 200_1 and the second satellite 200 may be referred to as transparent satellites. The first gNB 100 and the second gNB 100_2 can communicate via an inter-gNB link 402.

According to an example embodiment, the first cell 2_1 and/or the second cell 1_3 are Earth-fixed cells and the at least one client device needs to be served by the network node device due to the second satellite moving out-of-range for serving the at least one client device.

When the second satellite 200 moves from one Earth-fixed area to another, it needs to hand over the client devices 300 in the first cell 2_1 to the first satellite 200_1. In order to avoid using extra beams for the switching, a new cell 1_3 can be routed between the satellites using an inter-satellite link, in the case of regenerative and transparent satellites, or between network node devices using an inter-gNB link 402 in the case of transparent satellites. Thus, no extra beams may be needed, as the second satellite 200 can provide multiple cells via the same beam.

According to an example embodiment, the satellite 200 is further configured to provide the first cell 2_1 and the second cell 1_3 using a single antenna beam.

After the at least one client device 300 has performed a handover from the first cell 2_1 to the second cell 1_3, the second cell 1_3 can be switched from being provided by the second satellite 200 to being provided by the first satellite 200_1. This results in a hard switch in terms of steering beams, as the client devices 300 are already connected to the correct cells. In order to avoid issues due to the hard satellite switch, additional measures can be taken. The client devices 300 can be notified of the new satellite parameters, such as satellite doppler shift, and the timing of the switch. Additionally, scheduling and measurements during the switch can be prohibited so that the switch can be aligned.

At least some example embodiments can reduce satellite complexity as no extra beams are needed and reduced energy consumption for satellite due to less beams. Additionally, the switching can be simpler, as the whole footprint can be switched at once.

The disclosure herein is also applicable for earth-moving cells (EMC), where the footprints overlap, and the proposed mechanism could also provide benefit because the client device 300 would not need to detect inter-satellite cell borders and all intra-satellite HO mechanism can be used.

Due to the switching, beams from the two satellites do not need to be steered simultaneously to one area to allow the at least one client device to perform a handover. This would require extra beams are that are enabled only during the switching. These extra beams would yield a higher satellite complexity and power consumption. Thus, the switching can reduce satellite complexity and power consumption.

FIG. 5 illustrates an example embodiment of the subject matter described herein illustrating cell switching via an inter-satellite link in a system with transparent satellites.

A constellation of satellites can also implement inter-satellite links (ISL). These are direct links between two satellites and can be used for different purposes, such as to route satellite data to the few gateways.

In the example embodiment of FIG. 5, the first satellite 200_1 and the second satellite 200 can communicate via an inter-satellite link 401. The second cell 1_3 can be routed to the second satellite via the inter-satellite link 401.

Any disclosure in relation to the example embodiment of FIG. 4 may also apply to the example embodiment of FIG. 5. Instead of using the inter-gNB link 402 of the example embodiment of FIG. 4, the inter-satellite link 401 of the example embodiment of FIG. 5 may be used.

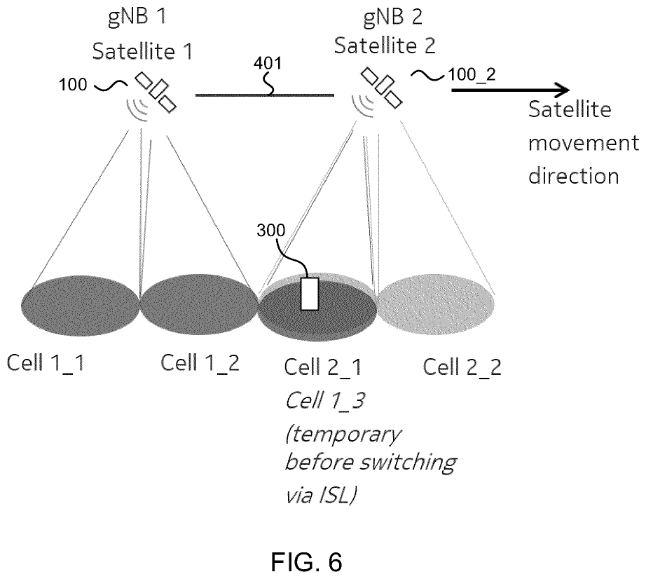

FIG. 6 illustrates an example embodiment of the subject matter described herein illustrating cell switching via an inter-satellite link in a system with regenerative satellites.

In the example embodiment of FIG. 6, the first network node device 100 is placed on the first satellite 200_1 and the second network node device 100_2 is placed on the second satellite 200. In such a configuration, the satellites may be referred to as regenerative satellites.

According to an example embodiment, the first satellite and the second satellite are connected via an inter-satellite link 401 and/or the network node device 100 and the second network node device 100_2 are connected via an inter-gNB link 402 and the second cell 1_3 is routed to the second satellite 200 via the inter-satellite link 401 and/or the inter-gNB link 402.

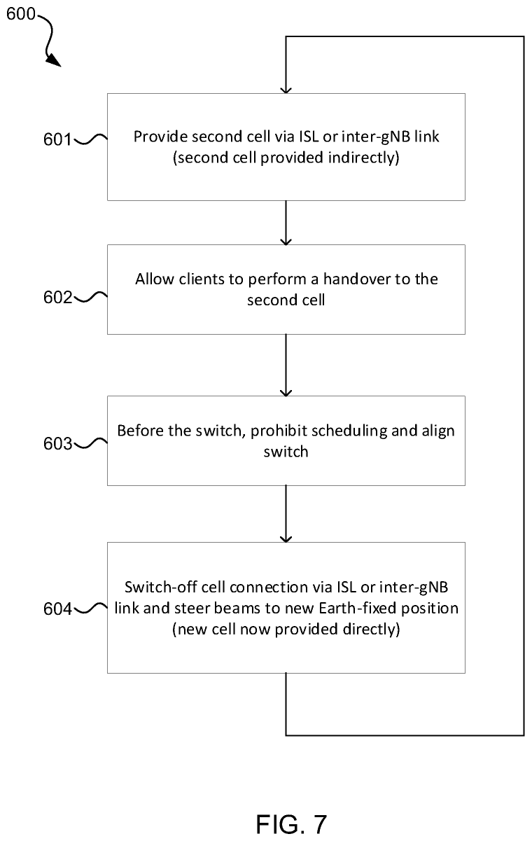

FIG. 7 illustrates an example embodiment of the subject matter described herein illustrating a flow chart 600 representation of cell switching.

A flowchart 600 for the satellite switch is shown in FIG. 7. In operation 601, shortly before the second satellite 200 leaves the coverage area, the second cell 1_3 can be provided via the air interface of second satellite 200 via the ISL or an inter-gNB link. Thus, the second cell 1_3 is now provided indirectly via the second satellite 200 as shown in the example embodiments of FIGS. 4-6.

In operation 602, the client devices 300 can be given some time to complete the handover from the first cell 2_1 to the second cell 1_3.

The first network node device 100 can collect information about the new satellite parameters, such as Doppler shift or timing advance. This information can be provided to the client devices 300 in order to avoid a break in the connection. Moreover, the client devices 300 can be notified of the upcoming switch from the indirect link via the second satellite 200 to a direct link via the first satellite 200_1.

According to an example embodiment, the network node device 100 is further configured to, before switching the second cell 1_3 to be provided by the first satellite 200_1, inform a timing of the switch to the at least one client device 300 and/or instruct the at least one client device 300 not to perform scheduling and/or measurements during the switch.

In operation 603, before the switch, scheduling and measurements can be prohibited.

In operation 604, the beam of the second satellite 200 can be switched off and the first satellite 200_1 can provide the second cell 1_3. The network node device 100 can perform these via, for example, the inter-gNB link 402 or the inter-satellite link 401. The first satellite 200_1 can steer beams to new Earth-fixed position. Thus, the second cell 1_3 is now provided by the network node device 100 via the first satellite 200_1.

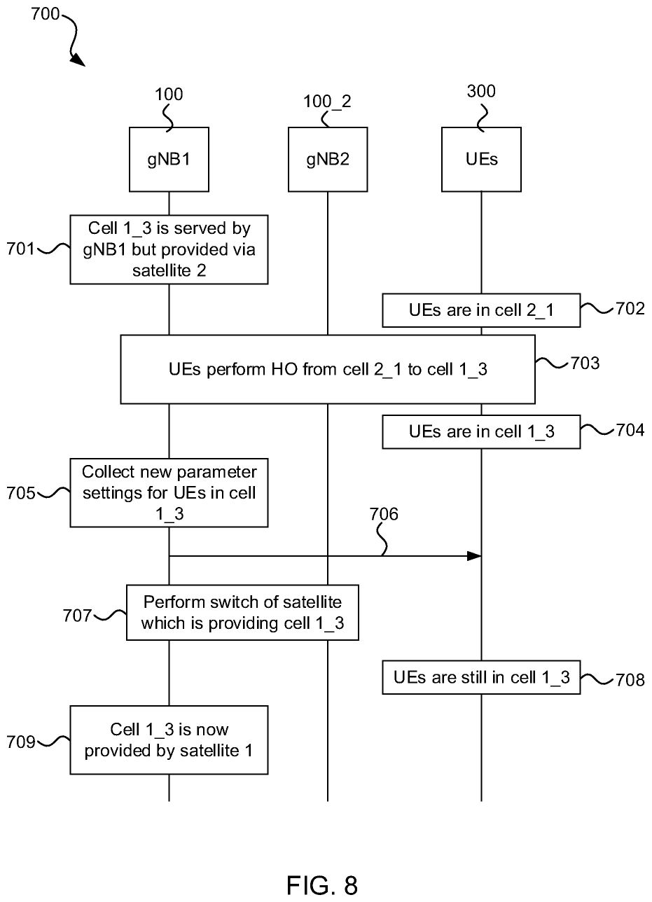

FIG. 8 illustrates an example embodiment of the subject matter described herein illustrating a signalling diagram 700 representation of cell switching.

The network node device 100 can provide 701 the second cell 1_3 via the second satellite 200.

According to an example embodiment, the network node device is further configured to, after providing the second cell 1_3 to the at least one client device via the second satellite 200, instruct the at least one client device to perform a handover from the first cell 2_1 to the second cell 1_3.

First, the client device 300 can be 702 in the first cell 2_1. The client device can then perform 703 a handover from the first cell 2_1 to the second cell 1_3. After which, the client device 300 can be 704 in the second cell 1_3.

The network node device 100 can collect 705 new parameter settings for the client device 300 in the second cell 1_3 and inform 706 the parameter settings to the client device 300.

According to an example embodiment, the network node device 100 is further configured to collect 705 new satellite parameter settings for the at least one client device and inform 706 the new satellite parameter settings to the at least one client device before switching the second cell to be provided by the first satellite.

The new satellite parameter settings can comprise satellite parameter settings that the client devices 300 should use when in the second cell 1_3.

According to an example embodiment, the new satellite parameter settings comprise at least one of: Doppler shift, path loss, transmit power, satellite ephemeris, and/or timing advance.

Alternatively to informing the satellite parameter settings after the handover from the first cell 2_1 to the second cell 1_3, the network node device 100 can inform the satellite parameter settings before the handover.

The network node device 100 can then perform switching 707 of the second cell 1_3 from the second satellite 200 to the first satellite 200_1. After which, the client devices 300 are 708 still in the second cell 1_3, but the second cell 1_3 is provided 709 by the first satellite 200_1 and served by the network node device 100.

At least some of the following measures can be taken in order to not corrupt ongoing transmissions and the connection to the current cell. The client devices 300 can be prepared for the parameter change. Transmission gaps can be introduced. Gaps where no measurements are taken can be introduced. The client devices 300 can be notified of oncoming parameter changes, such as new satellite ephemeris, derive Doppler shift, timing advance, and/or pathloss. Switch timing and duration can be made known to client devices 300. For example, scheduling/transmissions can be prohibited and/or measurements of the serving cell may not make sense and can be prohibited.

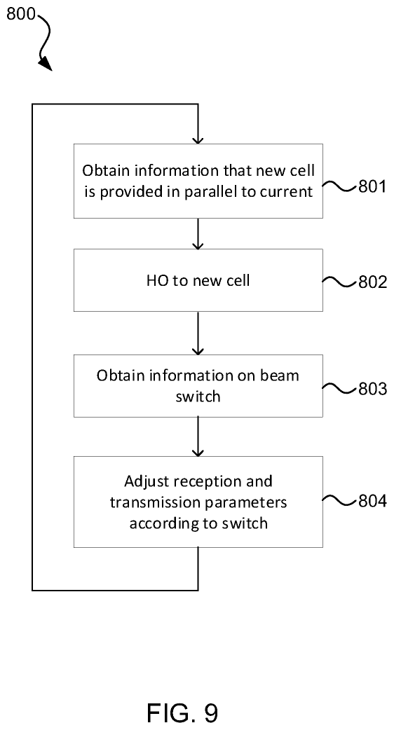

FIG. 9 illustrates an example embodiment of the subject matter described herein illustrating a flow chart representation 800 of client device cell switching.

In operation 801, the client device 300 is currently served by the second network node device 200 via the first cell 2_1. The client device 300 is informed by the network about the availability of a second cell 1_3, sent in parallel to the current beam. The second cell 1_3 may appear to the client device 300 just as if it were sent directly by the first satellite 200_1, even though it is physically sent by the second satellite 200. The second cell 1_3 may be announced by the first cell 2_1 or the client device 300 may detect it by a way of configured or periodic measurements.

In operation 802, the client device 300 can perform a handover to the second cell 1_3. The handover can be triggered either by, for example, the measurements or by a direct handover request.

In operation 803, the client device 300 can obtain information when the cell switch going to occur.

In operation 804, the client device 300 can suspend transmission and reception for the duration of the cell switch. The client device 300 can adjust the radio parameters after the switch according to new satellite parameter settings. The satellite parameter settings that are adjusted can be, for instance, transmit power and/or timing advance. However, no handover may be necessary at this point.

According to an example embodiment, the client device 100 is further configured to obtain new satellite parameter settings for the first satellite 200_1 from the first network node device 100 and use the new satellite parameter settings after the second cell 1_3 has been switched to being provided by the first satellite 200_1.

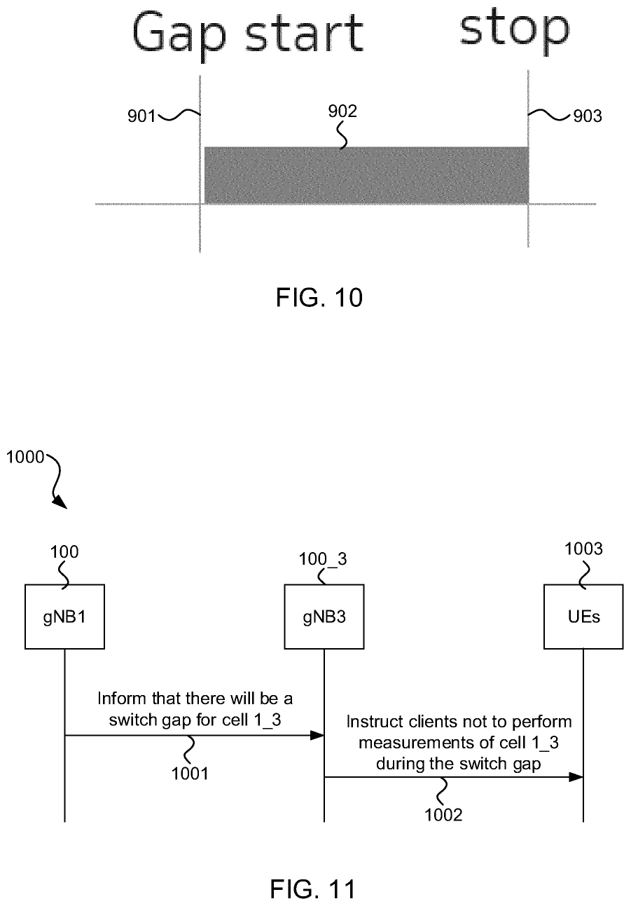

FIG. 10 illustrates an example embodiment of the subject matter described herein illustrating a switch gap.

The switch from indirect connection via the second satellite 200 to the direct connection to the first satellite 200_1 may occur during a single instant or during a switch gap 902 with a start 901 and a stop 903 time. The example embodiment of FIG. 10 illustrates an example of such a gap. New parameters can take effect at end 903 of gap.

According to an example embodiment, the network node device 100 is further configured to implement a switch gap 902 during which the network node device 100 switches the second cell 1_3 to be provided by the first satellite 200_1 and instructs the at least one client device 300 not to perform scheduling and/or measurements during the switch gap 902 and/or instruct the at least one client device 300 to take the new satellite parameter settings into use after the switch gap 902.

For carrying out the switch it can be advantageous for the switch gap 902 to be designed to be aligned to a frame or slot-boundary index. This can avoid disrupting packet transmissions. Alternatively or additionally, the switch gap 902 can be aligned to a synchronization signal block (SSB) period. This can facilitate acquiring new synchronization signals immediately. Alternatively or additionally, the switch gap stop 903 can be aligned with a system information (SI) period start. This can facilitate acquiring new system information immediately.

The switch gap 902 may be also designed as a one-time cell-wide measurement timing configuration (SMTC) with no serving cell measurements. Neighbour cell measurements may be carried out.

FIG. 11 illustrates an example embodiment of the subject matter described herein illustrating a signalling diagram 1000 for switch gap signalling.

The switch gap 902 may be also notified to neighbour cells and their client devices, with the purpose of making sure that the client devices of neighbour cells do not take measurements of the second cell 1_3 or perform random access channel (RACH) operations or handover to the second cell 1_3 during the switch gap 902.

The network node device 100 can informing 1001 another network node device 100_3, such as a neighbouring network node device, about the switch gap 902. The other network node device 100_3 can instruct 1002 client devices 1003 served by the other network node device 100_3 not to perform measurements of the second cell 1_3 during the switch gap.

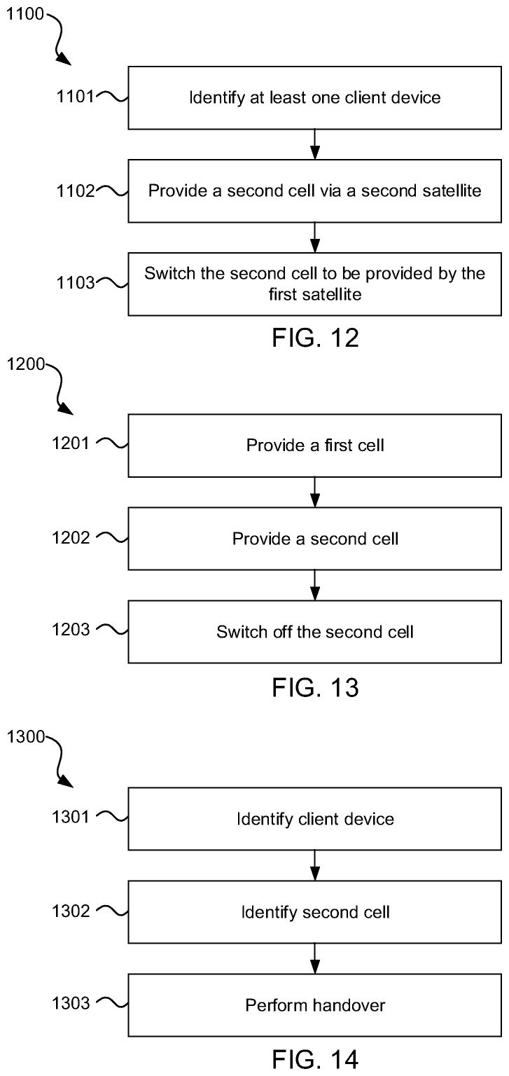

FIG. 12 illustrates an example embodiment of the subject matter described herein illustrating a flow chart representation of a method.

According to an example embodiment, the method 1100 comprises, when a network node device is connected to a first satellite of a non-terrestrial network, identifying 1101 at least one client device needing to be served by the network node device, wherein the at least one client device is currently served by a second network node device via a first cell provided by a second satellite of the non-terrestrial network.

The method 1100 may further comprise, in response to identifying that the at least one client device needs to be served by the network node device, providing 1102 a second cell to at least one the client device via the second satellite.

The method 1100 may further comprise, after the at least one client device has performed a handover from the first cell to the second cell, switching 1103 the second cell to be provided by the first satellite. The method 1100 may be performed by, for example, the network node device 100.

FIG. 13 illustrates an example embodiment of the subject matter described herein illustrating a flow chart representation of another method.

According to an example embodiment, the method 1200 comprises, providing 1201 a first cell to at least one client device, wherein the at least one client device is served by a second network node device via the first cell.

The method 1200 may further comprise, in response to the at least one client device needing to be served by a first network node device, providing 1202 a second cell to the at least one client device, wherein the at least one client device is served by the first network node device via the second cell.

The method 1200 may further comprise, after the at least one client device has performed a handover from the first cell to the second cell, switching off 1203 the second cell, allowing the second cell to be provided by a first satellite.

The method 1200 may be performed by, for example, the satellite 200.

FIG. 14 illustrates an example embodiment of the subject matter described herein illustrating a flow chart representation of another method.

According to an example embodiment, the method 1300 comprises identifying 1301 that a client device needs to be served by a first network node device, wherein the first network node device is connected to a first satellite of a non-terrestrial network, wherein the client device is currently served by a second network node device via a first cell provided by a second satellite of the non-terrestrial network.

The method 1300 may further comprise, in response to identifying that the client device needs to be served by the first network node device, identifying 1302 a second cell served by the first network node device and provided by the second satellite.

The method 1300 may further comprise performing 1303 a handover of the client device from the first cell to the second cell, wherein the second cell is switched to being provided by the first satellite after the handover.

The method 1300 may be performed by, for example, the client device 300.

An apparatus may comprise means for performing any aspect of the method(s) described herein. According to an example embodiment, the means comprises at least one processor, and memory comprising program code, the at least one processor, and program code configured to, when executed by the at least one processor, cause performance of any aspect of the method.

The functionality described herein can be performed, at least in part, by one or more computer program product components such as software components. According to an example embodiment, the network node device 100 comprises a processor configured by the program code when executed to execute the example embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAS), Application-specific Integrated Circuits (ASICs), Application-specific Standard Products (ASSPs), Systemon-a-chip systems (SOCs), Complex Programmable Logic Devices (CPLDs), and Graphics Processing Units (GPUs). Any range or device value given herein may be extended or altered without losing the effect sought. Also any example embodiment may be combined with another example embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the example embodiments described above may be combined with aspects of any of the other example embodiments described to form further example embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various example embodiments have been described above with a certain degree of particularity, or with reference to one or more individual example embodiments, those skilled in the art could make numerous alterations to the disclosed example embodiments without departing from the spirit or scope of this specification.

1-17. (canceled)

18. A network node device, comprising:
at least one processor; and
at least one memory including computer program code;
the at least one memory and the computer program code configured to, with the at least one processor, cause the network node device to:
when the network node device is connected to a first satellite of a non-terrestrial network, identify at least one client device needing to be served by the network node device, wherein the at least one client device is currently served by a second network node device via a first cell provided by a second satellite of the non-terrestrial network;
in response to identifying that the at least one client device needs to be served by the network node device, provide a second cell to at least one the client device via the second satellite; and
after the at least one client device has performed a handover from the first cell to the second cell, switch the second cell to be provided by the first satellite.

19. The network node device according to claim 18, wherein the first cell and/or the second cell are Earth-fixed cells and the at least one client device needs to be served by the network node device due to the second satellite moving out-of-range for serving the at least one client device.

20. The network node device according to claim 18, wherein the at least one memory and the computer program code are further configured to, with the at least one processor, cause the network node device to, after providing the second cell to the at least one client device via the second satellite, instruct the at least one client device to perform a handover from the first cell to the second cell.

21. The network node device according to claim 18, wherein the at least one memory and the computer program code are further configured to, with the at least one processor, cause the network node device to, before switching the second cell to be provided by the first satellite, inform a timing of the switch to the at least one client device and/or instruct the at least one client device not to perform scheduling and/or measurements during the switch.

22. The network node device according to claim 18, wherein the first satellite and the second satellite are connected via an inter-satellite link and/or the network node device and the second network node device are connected via an inter-gNB link and wherein the second cell is routed to the second satellite via the inter-satellite link and/or the inter-gNB link.

23. The network node device according to claim 18, wherein the at least one memory and the computer program code are further configured to, with the at least one processor, cause the network node device to:
collect new satellite parameter settings for the at least one client device; and
inform the new satellite parameter settings to the at least one client device before switching the second cell to be provided by the first satellite.

24. The network node device according to claim 23, wherein the new satellite parameter settings comprise at least one of: Doppler shift, pathloss, transmit power, satellite ephemeris, and/or timing advance.

25. The network node device according to claim 18, wherein the at least one memory and the computer program code are further configured to, with the at least one processor, cause the network node device to:
implement a switch gap during which the network node device switches the second cell to be provided by the first satellite; and
instruct the at least one client device not to perform scheduling and/or measurements during the switch gap and/or instructs the at least one client device to take the new satellite parameter settings into use after the switch gap.

26. A satellite, comprising:
at least one processor; and
at least one memory including computer program code;
the at least one memory and the computer program code configured to, with the at least one processor, cause the satellite to:
provide a first cell to at least one client device, wherein the at least one client device is served by a second network node device via the first cell;
in response to the at least one client device needing to be served by a first network node device, provide a second cell to the at least one client device, wherein the at least one client device is served by the first network node device via the second cell; and
after the at least one client device has performed a handover from the first cell to the second cell, switch off the second cell, allowing the second cell to be provided by a first satellite.

27. The satellite according to claim 26, wherein the at least one memory and the computer program code are further configured to, with the at least one processor, cause the satellite to provide the first cell and the second cell using a single antenna beam.

28. The satellite according to claim 26, wherein the first cell and/or the second cell are Earth-fixed cells and the at least one client device needs to be served by the first network node device due to the satellite moving out-of-range for serving the at least one client device.

29. A client device, comprising:
at least one processor; and
at least one memory including computer program code;
the at least one memory and the computer program code configured to, with the at least one processor, cause the client device to:
identify that the client device needs to be served by a first network node device, wherein the first network node device is connected to a first satellite of a non-terrestrial network, wherein the client device is currently served by a second network node device via a first cell provided by a second satellite of the non-terrestrial network;
in response to identifying that the client device needs to be served by the first network node device, identify a second cell served by the first network node device and provided by the second satellite; and
perform a handover from the first cell to the second cell, wherein the second cell is switched to being provided by the first satellite after the handover.

30. The client device according to claim 29, wherein the at least one memory and the computer program code are further configured to, with the at least one processor, cause the client device (to:
obtain new satellite parameter settings for the first satellite from the first network node device; and
use the new satellite parameter settings after the second cell has been switched to being provided by the first satellite.
